(19) United States
(12) Patent Application Publication
(10) Pub. No.: US 2025/0087247 A1
(43) Pub. Date: Mar. 13, 2025

(54) MAGNETIC RECORDING/REPRODUCING DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Shino Zaima, Kamakura Kanagawa (JP); Akiyo Mizutani, Kawasaki Kanagawa (JP)

(21) Appl. No.: 18/431,311

(22) Filed: Feb. 2, 2024

(30) Foreign Application Priority Data
Sep. 12, 2023 (JP) 2023-147683

(51) Int. Cl. G11B 33/14

(52) U.S. Cl. CPC G11B 33/146

(57) ABSTRACT

According to one embodiment, a magnetic recording/reproducing device includes a housing which accommodates a magnetic recording medium, and a magnetic head which records or reproduces magnetic data relative the magnetic recording medium, and a synthetic adsorbent provided in the housing and containing a polystyrene-divinylbenzene copolymer.

### CROSS-REFERENCE TO RELATED APPLICATIONS

This application is based upon and claims the benefit of priority from Japanese Patent Application No. 2023-147683, filed Sep. 12, 2023, the entire contents of which are incorporated herein by reference.

### FIELD

Embodiments described herein relate generally to a magnetic recording/reproducing device.

### BACKGROUND

Contaminations of media and heads cause failure in magnetic recording/reproducing devices. Therefore, conventionally, activated carbon is attached to respiration filters to adsorb organic outgas. However, as the respiration filters are provided away from the heads and media, the gaseous adsorption efficiency near the media and heads is poor. In addition, activated carbon easily generates particles. Thus, the intended use is limited in terms of processing. A technique of attaching, instead of activated carbon, a case in which graphene particles are sealed to the inside of an HDD to absorb gas is known. However, improvement of processability or generation of particles is insufficient.

### BRIEF DESCRIPTION OF THE DRAWINGS

FIG. 1 is an exploded perspective view showing the base and top cover of a hard disk drive (HDD) according to an embodiment.

FIG. 2 is a plan view of the HDD in a state where the cover is removed.

FIG. 3 is a perspective view showing part of the head stack assembly (HSA) of the HDD.

FIG. 4 is a plan view of the HDD according to example 1-2.

FIG. 5 is a cross-sectional view of a spoiler.

FIG. 6 is an exploded perspective view of the HDD according to example 2-1.

FIG. 7 is a plan view of the HDD according to example 2-1 in a state where the cover is removed.

FIG. 8 is a cross-sectional view taken along the A-A line of FIG. 7.

FIG. 9 is a plan view showing an example of a synthetic adsorbent filter.

FIG. 10 is a plan view showing another example of the synthetic adsorbent filter.

### DETAILED DESCRIPTION

In general, according to one embodiment, a magnetic recording/reproducing device comprises a housing which accommodates a magnetic recording medium, and a magnetic head which records or reproduces magnetic data relative the magnetic recording medium, and a synthetic adsorbent provided in the housing and containing a polystyrene-divinylbenzene copolymer.

According to the embodiment, outgas can be adsorbed without generating dust such as particles by using a synthetic adsorbent containing a polystyrene-divinylbenzene copolymer, and thus, contaminations can be reduced.

The synthetic adsorbent may be applied to at least part of a component provided inside the housing. Alternatively, the synthetic adsorbent may be provided in a gap between the magnetic recording medium and the housing.

Here, the application includes the following configuration.

For example, the component may be formed of the synthetic adsorbent. Alternatively, the component may be formed of a mixture containing the synthetic adsorbent and another material.

Further, for example, the component may comprise a component body, and a coating film provided on the component body and containing the synthetic adsorbent. As the coating film, an application film of the synthetic adsorbent may be used. An adhesive layer may be further provided between the component body and the coating film. For example, a synthetic adsorbent adsorption sheet may be prepared by stacking an adhesive layer on a sheet-like synthetic adsorbent and may be attached to the component.

For the component, a head stack assembly (HSA), an inner stopper, a VCM sleeve, a spoiler or a desiccant housing case is considered.

The synthetic adsorbent may be provided in at least part of the head stack assembly, for example, a side surface of the head stack assembly. The synthetic adsorbent may be provided in at least part of the spoiler, for example, a side surface of the spoiler. The synthetic adsorbent may be provided in at least part of each of the desiccant housing case, the inner stopper and the VCM sleeve, for example, an external surface of each of these components. Each of the spoiler, the desiccant housing case, the inner stopper and the VCM sleeve may be formed of the synthetic adsorbent or a mixture containing the synthetic adsorbent and another material.

The synthetic adsorbent provided in the gap between the magnetic recording medium and the housing may be formed into a plate. The plate may comprise a perforated structure having a net-like shape, such as a grating shape, a honeycomb structure, etc.

The synthetic adsorbent to be used may comprise a functional group on a surface depending on the need.

Hereinafter, embodiments are specifically explained with reference to some examples.

### EXAMPLES

### Examples 1

Each example 1 shows, as an example for applying a synthetic adsorbent to a component provided inside a housing, a case where a synthetic adsorbent adsorption sheet is attached to a component or a synthetic adsorbent layer is applied.

The position for attaching a synthetic adsorbent can be a position in a direction perpendicular to the direction of the air current at the time of operation, or a position at which the air current changes. As the probability of collision between the synthetic adsorbent and an organic gas is increased, an increase in adsorption efficiency can be expected.

As the method for providing a synthetic adsorbent, synthetic resin in the form of a sheet may be attached by an adhesive, or a synthetic adsorbent may be applied in the form of liquid and cured. Regarding the adhesive, there are some points to notice. For example, a side surface of an HSA is formed of aluminum having a high thermal expansion coefficient. If a thermosetting adhesive is used, there is a possibility that the adsorbent is damaged by a thermal stress at the time of adhesion. Thus, for the adhesive, a UV curable adhesive should be preferably used. However, thermosetting resin may be used depending on the material of the HSA and the heatproof temperature of the adsorbent.

Further, the adhesive may be adjusted so as not to contain a component having a bad affinity depending on the synthetic adsorbent. As resin is commonly weak relative to organic solvents, resin can be cured immediately after the application of the adhesive without an interval. Even if a material which contains an adhesive component which easily dissolves is daringly selected, the adhesion may be made stronger by dissolving the installation portion to the extent that the fine-pore structure is not destroyed.

Embodiments will be described hereinafter with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by the same reference numerals and their detailed descriptions may be omitted unless necessary.

This specification explains a hard disk drive (HDD) according to a first embodiment as a disk device in detail.

### Example 1-1

Example 1-1 shows an example in which an HSA is used as a component to which a synthetic adsorbent is applied.

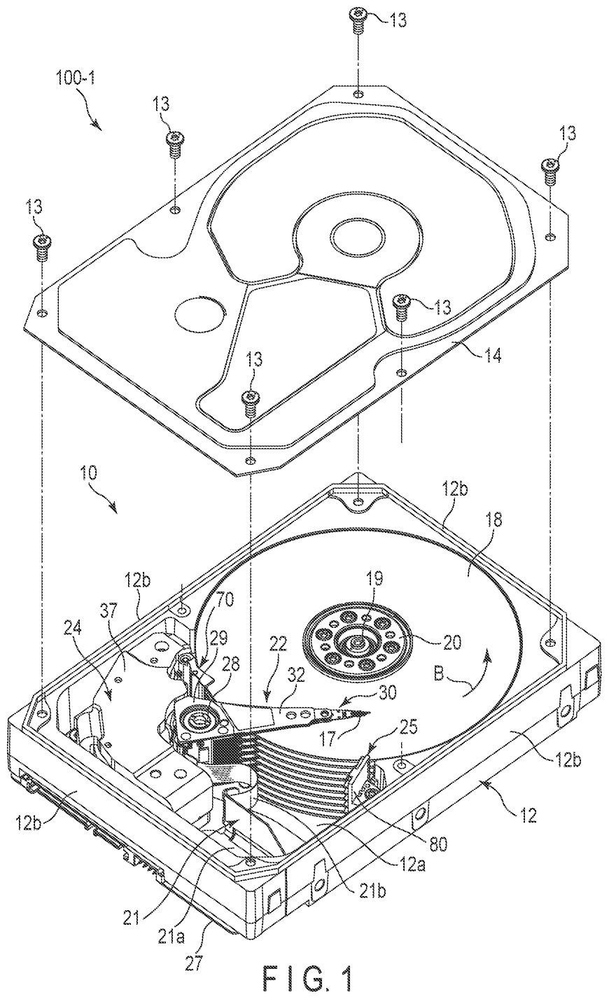

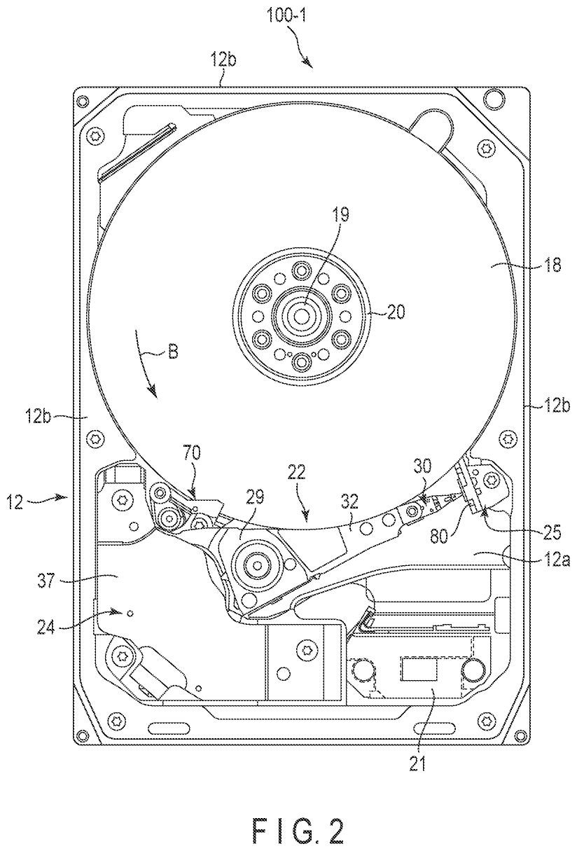

FIG. 1 is an exploded perspective view of the HDD in which a cover is removed according to example 1-1. FIG. 2 is a plan view of the HDD in a state where the cover is removed according to example 1-1.

As shown in FIG. 1, the HDD 100-1 comprises a rectangular housing 10. The housing 10 comprises a base 12 having the shape of an open-topped rectangular box, and a cover (top cover) 14. The base 12 comprises a rectangular bottom wall 12a, and a sidewall 12b provided upright along the periphery of the bottom wall, and is integrally formed of, for example, aluminum. For example, the cover 14 is formed of stainless steel into the shape of a rectangular plate. The cover 14 is screwed onto the sidewall 12b of the base 12 by a plurality of screws 13 and airtightly blocks the upper opening of the base 12.

As shown in FIG. 1 and FIG. 2, the housing 10 accommodates, as recording media having disk-like shapes, a plurality of, for example, ten magnetic disks 18, and a spindle motor 19 which supports and rotates the magnetic disks 18. The spindle motor 19 is provided on the bottom wall 12a. Each magnetic disk 18 comprises, for example, a substrate which is formed of a nonmagnetic material such as glass into the shape of a circular plate having a diameter of 95 mm (3.5 inches), and magnetic recording layers formed on the upper surface (first surface) of the substrate and the lower surface (second surface). The magnetic disks 18 are coaxially fitted into the hub of the spindle motor 19 described later, and further, are clamped by a clamp spring 20. By this structure, the magnetic disks 18 are supported in a state located parallel to the bottom wall 12a of the base 12. The magnetic disks 18 are rotated in the rotational direction B the predetermined number of revolutions by the spindle motor 19. It should be noted that the number of mounted magnetic disks 18 is not limited to 10 and may be less than or equal to 9 or may be greater than 10.

The housing 10 accommodates a plurality of magnetic heads 17 which record and reproduce data relative to the magnetic disks 18, and an actuator assembly 22 as an HSA which movably supports the magnetic heads 17 relative to the magnetic disks 18. Further, the housing 10 accommodates a voice coil motor (VCM) 24 which rotates and positions the actuator assembly 22, a ramped loading mechanism 25 which holds the magnetic heads 17 at an unload position spaced apart from the magnetic disks 18 when the magnetic heads 17 have moved to the outermost circumferences of the magnetic disks 18, a substrate unit (FPC unit) 21 on which electronic components such as a conversion connector are mounted, and a spoiler 70 formed of synthetic resin such as polycarbonate or metal.

A printed circuit board 27 is screwed onto the external surface of the bottom wall 12a of the base 12. The printed circuit board constitutes a control unit which controls the operation of the spindle motor 19 and controls the operation of the VCM 24 and the magnetic heads 17 via the substrate unit 21.

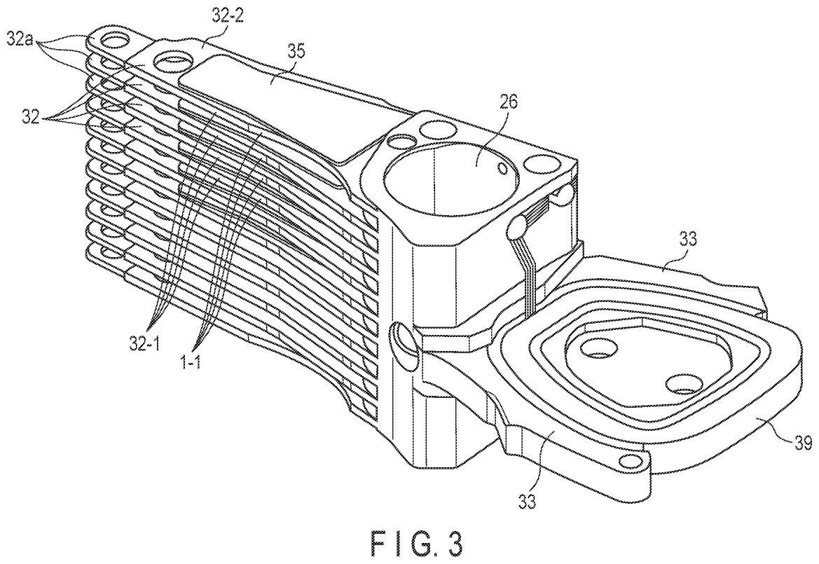

FIG. 3 is a perspective view in which part of the actuator assembly 22 is viewed in a load positional direction.

As shown in the figure, the actuator assembly 22 comprises an actuator block 29 comprising a through hole 26, a bearing unit (unit bearing) 28 provided inside the through hole 26, and a plurality of, for example, eleven arms 32 which extend from the actuator block 29.

In the embodiment, the actuator block 29 and the eleven arms 32 are integrally formed of aluminum, etc., and constitute an E-block. For example, each arm 32 is formed into the shape of a flat plate which is long and thin, and extends from the actuator block 29 in a direction orthogonal to a support shaft (not shown) inserted into the through hole 26. The eleven arms 32 are provided parallel to each other at intervals. A suspension assembly 30 can be attached to the extension end 32a of each arm 32.

The E-block comprises a support frame 33 which extends from the actuator block 29 in a direction opposite to the arms 32. By this support frame 33, a voice coil 39 which constitutes part of the VCM 24 is supported. As shown in FIG. 1, the voice coil 39 is located between a pair of yokes 37 one of which is secured onto the base 12, and constitutes the VCM 24 with these yokes 37 and a magnet secured to one of the yokes.

A coating film which contains a synthetic adsorbent as a synthetic adsorbent 1-1 is provided on, of the side surfaces of each arm 32 excluding the extension end 32a, the upstream side surface 32-1 regarding the rotational direction B of the magnetic disks 18. The synthetic adsorbent 1-1 can be provided by attaching a synthetic adsorbent adsorption sheet or applying a synthetic adsorbent to the side surface 32-1 of each arm 32 which is the component body. By this structure, organic gas and the like floating on the rotating magnetic disks 18 can be adsorbed by the synthetic adsorbents 1-1 of the upstream side surfaces 32-1. It should be noted that the attachment positions of the synthetic adsorbents 1-1 are not limited to this example. For example, the synthetic adsorbents 1-1 may be provided on the downstream side surfaces or on both the upstream side surfaces 32-1 and the downstream side surfaces.

A polystyrene-divinylbenzene copolymer used for the synthetic adsorbent is a porous body. For example, the polystyrene-divinylbenzene copolymer may have a micropore with a pore diameter of 15 angstroms to a macropore with a pore diameter of 80 angstroms, a pore capacity of 0.1 to 0.8 ml/g, a specific surface area of 500 to 1500 m²/g, and a water content of 35% to 50%. As this polystyrene-divinylbenzene copolymer, for example, PuroSorb (Purolite), Macronet (registered trademark) MN270 (Purolite) or the like may be used.

Polystyrene-divinylbenzene which does not have a functional group is effective for the adsorption of siloxane.

It is known that siloxane is generated from an adsorbent for attaching an ACB damper 35 located near the synthetic adsorbents 1-1 of FIG. 3. Reduction in a siloxane gas in the HDD can be expected by providing the synthetic adsorbents 1-1 which easily adsorb siloxane near the generation source of siloxane.

According to example 1-1, outgas can be adsorbed without generating dust such as particles by using the synthetic adsorbent 1-1. Thus, contaminations can be reduced.

### Example 1-2

Example 1-2 shows an example in which a spoiler is used as a component to which a synthetic adsorbent is applied.

Now, this specification explains the spoiler 70-1 of the HDD.

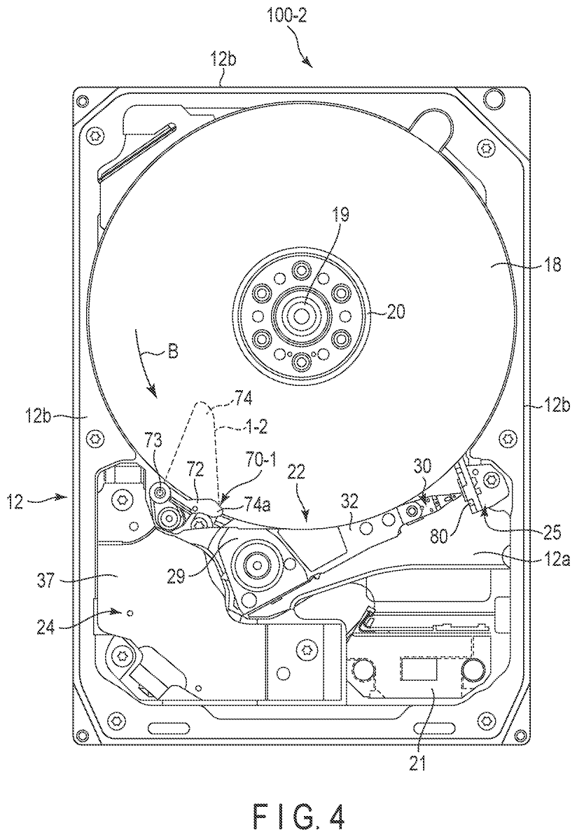

FIG. 4 is a plan view of the HDD according to example 1-2.

As shown in the figure, the HDD 100-2 comprises the same configuration as FIG. 1 and FIG. 2 except that, in place of the spoiler 70, the synthetic-resin or metal spoiler 70-1 which comprises a synthetic adsorbent 1-2 as a coating film containing a synthetic adsorbent is provided on a side surface of each blade 74 as part of the component body in the housing 10.

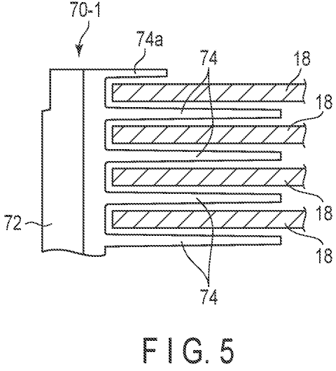

FIG. 5 is a cross-sectional view showing part of the spoiler and the magnetic disks.

As shown in FIG. 4 and FIG. 5, the spoiler 70-1 comprises a body 72, a support sleeve 73 provided in the body 72, and a plurality of blades 74 substantially perpendicularly extending from the body 72, and comprises a molded body integrally molded by synthetic resin or metal, and the synthetic adsorbent 1-2 further provided on a side surface of each blade 74. The synthetic adsorbent 1-2 can be provided by attaching a synthetic adsorbent adsorption sheet or applying a synthetic adsorbent. As shown in FIG. 4, the spoiler 70-1 is substantially perpendicularly provided on the bottom wall 12a by mounting the support sleeve 73 on the axis provided upright on the bottom wall 12a of the base 12. The spoiler 70-1 is provided near the outer periphery of each magnetic disk 18 on the upstream side of the actuator assembly 22 regarding the rotational direction B of the magnetic disks 18. As shown in FIG. 5, a plurality of, for example, eleven blades 74 are arranged substantially parallel to each other at predetermined intervals. Excluding the top blade 74a and the bottom blade (not shown), the other nine blades 74 extend between two adjacent magnetic disks 18, and face the outer circumferential portions of the magnetic disks 18 across intervening gaps. The top blade 74a faces the upper surface of the top magnetic disk 18 across an intervening gap. Similarly, the bottom blade faces the lower surface of the bottom magnetic disk 18 across an intervening gap.

Each blade 74 is formed such that the thickness gradually decreases from the proximal end portion to the distal end portion. The blades 74 of the spoiler 70 rectify the wind generated on the surfaces of the magnetic disks 18 and reduce the wind disturbance relative to the actuator assembly 22. This configuration can prevent the vibration of the actuator assembly 22 and improve the accuracy of the determination of the head position. As the air current largely changes near the spoiler, an effect of adsorbing gas by the synthetic adsorbent 1-2 before the attachment to the magnetic disks 18 can be expected. It is considered that gas is easily adsorbed in places where the change in air current is large.

According to example 1-2, outgas can be adsorbed without generating dust such as particles by using the synthetic adsorbent 1-2. Thus, contaminations can be efficiently reduced.

### Examples 2

Each example 2 shows a case where a synthetic adsorbent is molded into the shape of a component and is provided inside the HDD.

### Example 2-1

Example 2-1 shows a case where a component itself in the HDD is molded by synthetic adsorbent resin.

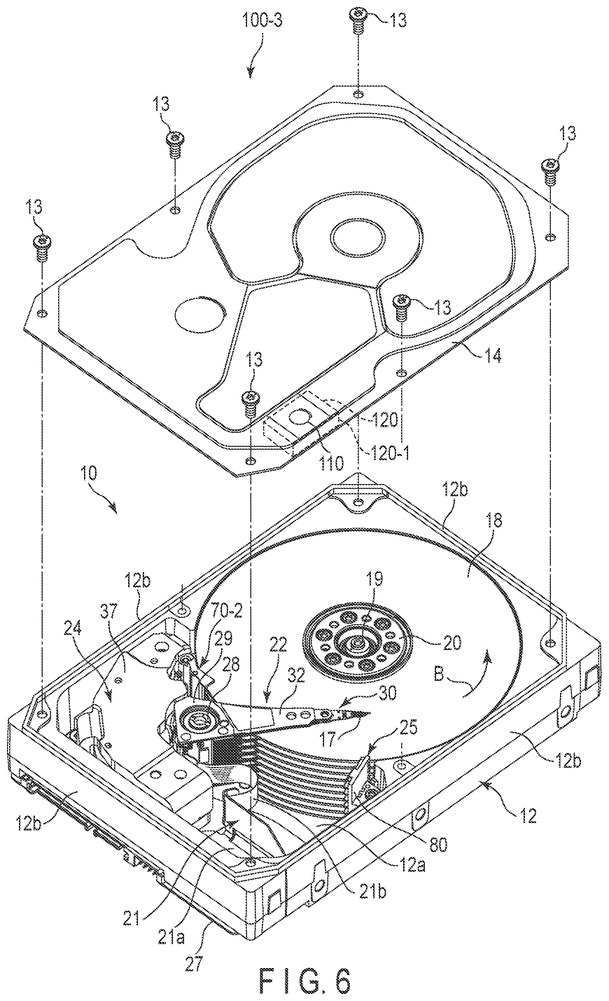

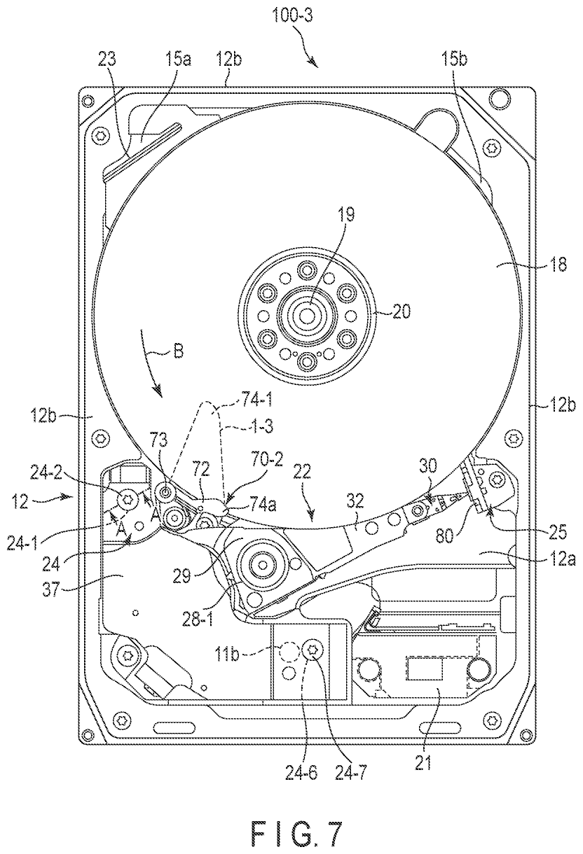

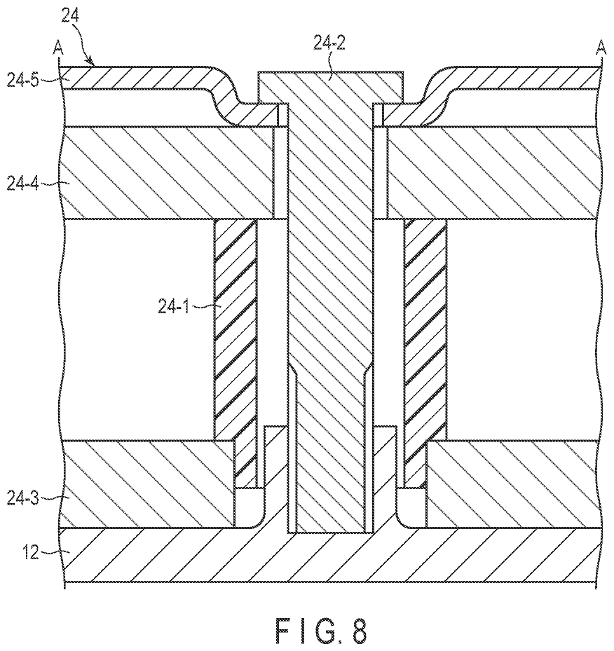

FIG. 6 is an exploded perspective view of the HDD in which the cover is removed according to example 2-1. FIG. 7 is a plan view of the HDD in a state where the cover is removed according to example 2-1. FIG. 8 is a cross-sectional view taken along the A-A line of FIG. 7 and showing the vicinity of the screw 24-2 of FIG. 7.

The materials of the components provided inside the HDD 100-3 can be arbitrarily changed to synthetic adsorbents. As synthetic adsorbents do not generate dust unlike activated carbon, direct attachment to a synthetic adsorbent containing a polystyrene-divinylbenzene copolymer without packaging is possible. FIG. 6 comprises the same configuration as FIG. 1 except that, in place of the spoiler 70, a spoiler 70-2 molded by using a synthetic adsorbent is provided, and a desiccant housing case 100-1 is provided. FIG. 7 comprises the same configuration as FIG. 2 except that, in place of the spoiler 70, the spoiler 70-2 molded by using a synthetic adsorbent is provided, and FIG. 7 comprises an inner stopper 11b formed of a synthetic adsorbent, a VCM 24 secured by the screw 24-2 comprising a VCM sleeve 24-1 formed of a synthetic adsorbent and a screw 24-7 comprising a VCM sleeve 24-6 formed of a synthetic adsorbent, a desiccant housing case 120-1 formed of a synthetic adsorbent, and an adsorption filter 23-1 formed of a synthetic adsorbent.

As shown in FIG. 6 and FIG. 7, the inner stopper 11b can be formed of a synthetic adsorbent, and can be provided so as to have, for example, a columnar shape, on the bottom wall 12a around the VCM 24. The use of the inner stopper 11b can suppress the impact which is caused by the collision with the column of the VCM when the HAS moves regarding the move of the head to the inner circumference of the magnetic disk 18.

As shown in FIG. 8, the VCM sleeve 24-1 is a cylindrical component molded by using a synthetic adsorbent and provided so as to cover the screw 24-2 securing the VCM 24 to the base 12. When the VCM sleeve 24-1 is provided, particles from the screw 24-2 do not easily spread to the inside of the HDD 100-3. In the figure, reference number 24-3 indicates the bottom surface of the VCM, and reference number 24-4 indicates the upper surface of the VCM, and reference number 24-5 indicates the cover provided on the upper surface 24-4 of the VCM. The VCM sleeve 24-6 comprises the same configuration as the VCM sleeve 24-1.

The spoiler 70-2 comprises a blade 74-1 as shown in FIG. 7, and comprises the same configuration as the spoiler 70-1 shown in FIG. 4 and FIG. 5 expect that the entire body is molded by a synthetic adsorbent 1-3.

The desiccant housing case 120-1 is the case of a desiccant 120 provided in the respiration hole 110 of the cover 14 of FIG. 6, and is formed of a synthetic adsorbent. The desiccant 120 is provided to adsorb outgas and reduce humidity. An adsorbent (not shown) can be put in the housing case 120-1. For the adsorbent, for example, activated carbon or silica gel can be used. When the desiccant housing case 120-1 itself is formed of a synthetic adsorbent, a further reduction in outgas can be expected.

When a synthetic adsorbent is molded into the shape of a component, strength or elasticity is a problem depending on the component. However, adjustment can be made by mixing the synthetic adsorbent with another resin.

For the components to which synthetic adsorbents can be applied, the inner stopper, the VCM sleeves, the spoiler and the desiccant housing case are shown. It should be noted that a synthetic adsorbent should be applied to at least one of these components. Synthetic adsorbents may be applied to components other than the above components.

According to example 2-1, outgas can be adsorbed without generating dust such as particles by using a synthetic adsorbent. Thus, contaminations can be reduced.

### Example 2-2

Example 2-2 shows a case where a synthetic adsorbent molded into the shape of a plate as an adsorption filter is provided in the path of the air current inside the HDD.

As shown in FIG. 7, a synthetic adsorbent plate 23 formed of a synthetic adsorbent can be provided in the path of the air current around the magnetic disks 18 provided inside the HDD, for example, a path 15a of the air current. The synthetic adsorbent plate 23 may be provided at an arbitrary position in the HDD in place of the path 15a of the air current, such as a path 15b of the air current, the HSA 22 or the path of the air current around the spoiler 70-2. The synthetic adsorbent plate 23 can be processed into various shapes.

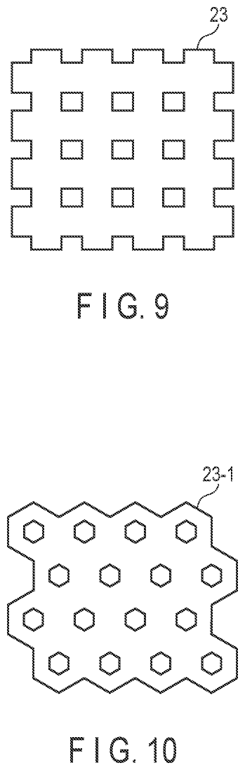

FIG. 9 and FIG. 10 are plan views showing the synthetic adsorbent plate used for example 2-2.

The synthetic adsorbent plate 23 can be processed into a plate comprising a perforated shape such as the grating shape shown in FIG. 9.

Alternatively, the synthetic adsorbent plate 23 may be processed into a plate 23-1 comprising a honeycomb structure as shown in FIG. 10. When the thickness of the plate is increased, the adsorption rate at the time of the passage of outgas is also increased. Therefore, the perforated shape and thickness can be arbitrarily adjusted to the extent that the plate does not interrupt the air current. Gas adsorption can be expected by placing the plate at a position in the air current and the path of gas. It should be noted that the plate does not have holes if the plate is provided at a position which does not interrupt the air current and collides with outgas. When activated carbon is sealed in, packaging in a case is necessary. However, as the synthetic adsorbent used in the embodiment does not have the risk of generating dust, the synthetic adsorbent can be directly provided inside the HDD. In this manner, the volume of the thickness of the case of the adsorption filter in which activated carbon is sealed can be reduced by using the synthetic adsorbent plate formed of a synthetic adsorbent. Thus, the size can be reduced. Further, outgas can be adsorbed without generating dust such as particles. In this manner, contaminations can be reduced.

### Example 3

Example 3 shows a case where adsorption characteristics are selected based on the presence or absence of a functional group in a polystyrene-divinylbenzene copolymer.

A polystyrene-divinylbenzene copolymer which does not have a functional group is effective for the adsorption of siloxane.

It is known that siloxane is generated from the adhesive for attaching the ACB damper 35 onto, of each arm 32, a surface 32-2 parallel to the magnetic disks 18 near the synthetic adsorbent 1-1 of FIG. 3. According to the embodiment, the reduction in siloxane gas in the HDD can be expected by providing the synthetic adsorbent 1-1 which easily adsorbs siloxane near the generation source of siloxane.

The synthetic adsorbent can be prepared so as to be specialized in the adsorption of a specific component by adding a functional group. For example, when a hydrophilic gas should be adsorbed, a-OH group can be added. Alternatively, for example, a weakly basic anion functional group, or a strongly acidic cation functional group may be selected.

According to example 3, outgas can be adsorbed without generating dust such as particles by using the synthetic adsorbent. Thus, contaminations can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording/reproducing device comprising:
a housing which accommodates a magnetic recording medium, and a magnetic head which records or reproduces magnetic data relative the magnetic recording medium; and
a synthetic adsorbent provided in the housing and containing a polystyrene-divinylbenzene copolymer.

2. The magnetic recording/reproducing device of claim 1, wherein
the synthetic adsorbent is applied to at least part of a component provided inside the housing.

3. The magnetic recording/reproducing device of claim 2, wherein
the component is formed of the synthetic adsorbent.

4. The magnetic recording/reproducing device of claim 2, wherein
the component is formed of a mixture containing the synthetic adsorbent.

5. The magnetic recording/reproducing device of claim 2, wherein
the component comprises a component body, and a coating film provided on the component body and containing the synthetic adsorbent.

6. The magnetic recording/reproducing device of claim 5, wherein
the coating film is an application film of the synthetic adsorbent.

7. The magnetic recording/reproducing device of claim 5, wherein
an adhesive layer is further provided between the component body and the coating film.

8. The magnetic recording/reproducing device of claim 2, wherein
the component is a head stack assembly, and the synthetic adsorbent is provided in at least part of side surfaces of the head stack assembly.

9. The magnetic recording/reproducing device of claim 2, wherein
the component is at least one of an inner stopper, a VCM sleeve, a spoiler and a desiccant housing case.

10. The magnetic recording/reproducing device of claim 1, wherein
the synthetic adsorbent is provided in a gap between the magnetic recording medium and the housing.

11. The magnetic recording/reproducing device of claim 1, wherein
the synthetic adsorbent is a plate.

12. The magnetic recording/reproducing device of claim 11, wherein
the plate comprises a perforated structure having a net-like shape.

13. The magnetic recording/reproducing device of claim 1, wherein
the synthetic adsorbent comprises a functional group on a surface.
